(19) United States
(12) Patent Application Publication
(10) Pub. No.: US 2025/0335042 A1
(43) Pub. Date: Oct. 30, 2025

(54) NOVEL LIGHTWEIGHT MOUSE

(71) Applicant: Min WANG, Beijing (CN)

(72) Inventor: Min WANG, Beijing (CN)

(21) Appl. No.: 19/175,061

(22) Filed: Apr. 10, 2025

(30) Foreign Application Priority Data
Apr. 24, 2024 (CN) 2024208700646

(51) Int. Cl. G06F 3/0354; G06F 3/0362

(52) U.S. Cl. CPC G06F 3/03543; G06F 3/0362

(57) ABSTRACT

A novel lightweight mouse is provided, including a housing, and the housing includes a left button and a right button. A circuit board device is disposed in the housing, and a control input device and a scroll wheel are disposed on the circuit board device. A support part is disposed on a front end of the housing. A rear end of the housing includes a convex edge. The novel lightweight mouse has high practicality, simple structure, lighter weight, more convenient and flexible use, strong stability, and the production cost is greatly reduced.

### CROSS-REFERENCE TO RELATED APPLICATION

This application claims priority to Chinese Patent Application No. 202420870064.6, filed on Apr. 24, 2024, which is herein incorporated by reference in its entirety.

### TECHNICAL FIELD

The disclosure relates to the technical field of mouses, and more particularly to a novel lightweight mouse.

### BACKGROUND

Computer mouse is a basic peripheral for daily computer operation, which has continuously evolving design and function. Traditional mouse usually consists of three parts: housing, bottom housing and buttons, with a circuit board inside the housing. The weight and stability of the housing directly affect the user's comfort and operation accuracy. Limited by the mouse structure and production process, the traditional housing usually cannot be integrated with the bottom housing, resulting in a heavy weight of the mouse, which may cause hand fatigue for users after long-term use.

The disclosure abandons the bottom housing of the mouse and directly connects the circuit board in the housing to the housing, so that the disclosure has a simpler structure and lighter weight, reduces the difficulty of the production process, and also greatly reduces the production cost, and is more flexible and convenient to use.

### SUMMARY

A main objective of the disclosure is to provide a novel lightweight mouse which has high practicality, simple structure, lighter weight, more convenient and flexible use, strong stability and greatly reduces the production cost.

In order to achieve the above objective, the disclosure provides a novel lightweight mouse, including a housing. The housing includes a left button and a right button, a circuit board device is disposed in the housing, and a control input device and a scroll wheel are disposed on the circuit board device. A support part is disposed on a front end of the housing.

In an embodiment, a rear end of the housing includes a convex edge.

In an embodiment, the support part is an arc-shaped support part.

In an embodiment, the convex edge is an arc-shaped convex edge.

In an embodiment, a footpad is disposed on a bottom of the support part or a bottom of the convex edge.

In an embodiment, a first footpad and a second footpad are disposed on a left side and a right side of the support part respectively.

In an embodiment, the housing is a hollow housing.

In an embodiment, the convex edge is a hollow convex edge.

In an embodiment, the housing defines a first through-hole configured to install the scroll wheel, and the first through-hole is defined above the support part.

In an embodiment, support frames are disposed on an end of the first through-hole, and the first through-hole is connected to the support part through the support frames.

In an embodiment, the housing, the support part and the convex edge are integrally formed.

The beneficial effects of the technical solutions provided by the disclosure are as follows. 1. The novel lightweight mouse of the disclosure includes the housing, and the housing includes the left button and the right button. The circuit board device is disposed in the housing, and the control input device and the scroll wheel are disposed on the circuit board device. The support part is disposed on the front end of the housing. The disclosure abandons the bottom housing of the original mouse by connecting an end of the circuit board to the support part, and connecting the other end of the circuit board to the housing. The novel lightweight mouse of the disclosure has high practicality, lighter weight, simple structure, and more convenient and flexible use. 2. The rear end of the housing of the disclosure includes the convex edge, which has higher stability of use and strong reliability. 3. The disclosure can be integrally formed, which reduces the difficulty of production process and greatly reduces the production cost, and is suitable for widespread promotion.

### BRIEF DESCRIPTION OF DRAWINGS

In order to more clearly illustrate technical solutions in embodiments of the disclosure or in the related art, drawings required in the description of the embodiments or the related art will be briefly introduced below. Apparently, the drawings described below are merely some of the embodiments of the disclosure. For those skilled in the art, other drawings can be obtained based on the structures shown in these drawings without creative work.

FIG. 1 illustrates a schematic structural diagram of a novel lightweight mouse according to an embodiment of the disclosure.

FIG. 2 illustrates another schematic structural diagram of the novel lightweight mouse according to the embodiment of the disclosure.

FIG. 3 illustrates a schematic structural diagram of a housing of the novel lightweight mouse according to the embodiment of the disclosure.

FIG. 4 illustrates another schematic structural diagram of the housing of the novel lightweight mouse according to the embodiment of the disclosure.

FIG. 5 illustrates a schematic diagram of disassembling the novel lightweight mouse according to the embodiment of the disclosure.

FIG. 6 illustrates another schematic diagram of disassembling the novel lightweight mouse according to the embodiment of the disclosure.

FIG. 7 illustrates a schematic diagram of disassembling a circuit board device of the novel lightweight mouse according to the embodiment of the disclosure.

The realization of the purpose, functional features and advantages of the disclosure will be further described in conjunction with the embodiments and with reference to the drawings.

### DETAILED DESCRIPTION OF EMBODIMENTS

The technical solutions in the embodiments of the disclosure will be clearly and completely described in conjunction with the drawings in the embodiments of the disclosure. Apparently, the described embodiments are merely some of the embodiments of the disclosure, not all of them. Based on the embodiments of the disclosure, all other embodiments obtained by those skilled in the art without creative work are within the scope of protection of the disclosure.

It should be noted that all directional indications in the embodiments of the disclosure (such as up, down, left, right, front, and rear) are only used to explain the relative position relationship and movement status between the components under a certain specific posture (as shown in the drawings). If the specific posture changes, the directional indications will also change accordingly.

In the disclosure, unless otherwise clearly specified and limited, the terms “connect” and “fix” should be understood in a broad sense. For example, “fix” can be a fixed connection, a detachable connection, or an integral connection. It can be a mechanical connection or an electrical connection. It can be a direct connection or an indirect connection through an intermediate medium, and it can be the internal connection of two elements or the interaction relationship between two elements, unless otherwise clearly defined. For those skilled in the art, the specific meanings of the above terms in the disclosure can be understood according to specific circumstances.

In addition, in the disclosure, descriptions such as “first” and “second” are only used for descriptive purposes and cannot be understood as indicating or implying their relative importance or implicitly indicating the number of the indicated technical features. Therefore, the features defined as “first” and “second” may explicitly or implicitly include at least one of the features. In addition, the technical solutions between the various embodiments can be combined with each other, but they must be based on the ability of those skilled in the art to implement them. When the combination of technical solutions is contradictory or cannot be implemented, it should be deemed that such a combination of technical solutions does not exist and is not within the scope of protection required by the disclosure.

The disclosure provides a novel lightweight mouse.

### Embodiment 1

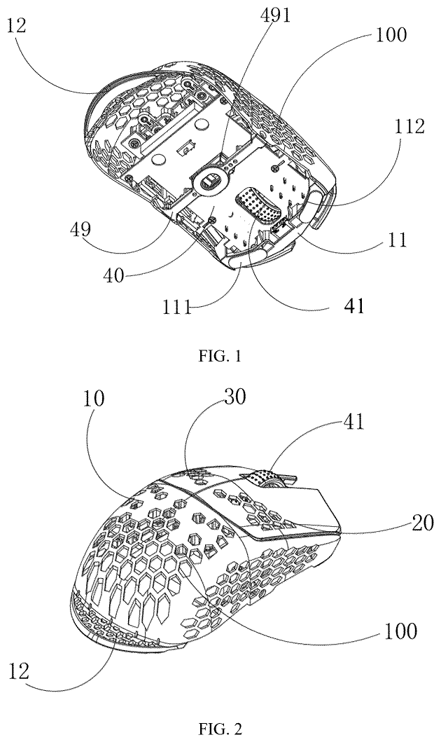

Referring to FIG. 1 to FIG. 7, in an embodiment of the disclosure, a novel lightweight mouse 100 includes a housing 10, and the housing 10 includes a left button 30 and a right button 20. A circuit board device is disposed in the housing 10. In an embodiment, the circuit board device includes a circuit board 40, and a control input device 43 and a scroll wheel 41 are disposed on the circuit board device.

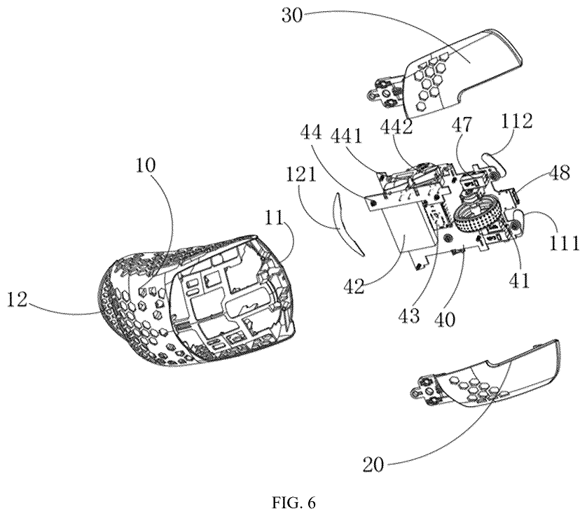

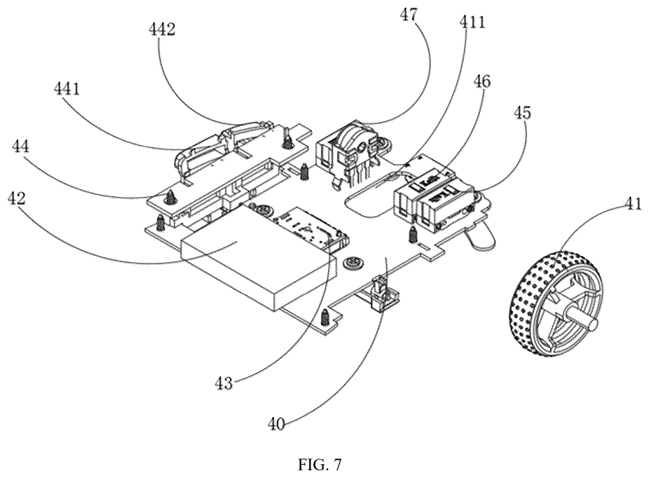

Referring to FIG. 5, FIG. 6 and FIG. 7, in an embodiment, the circuit board 40 includes a battery 42, the control input device 43, a side button circuit board 44 is disposed on a left side of the circuit board 40, and the side button circuit board 44 includes a first side button 441 and a second side button 442. An end of the circuit board 40 facing towards the scroll wheel 41 is a front end of the circuit board 400. A button switch 45 and a scroll wheel button switch 46 are disposed on a right side of the scroll wheel 41 side by side. A scroll wheel encoder 47 is disposed on a left side of the scroll wheel 41, and a universal serial bus (USB) interface 48 is disposed on a lower part of a front end of the scroll wheel 41.

Referring to FIG. 1, in an embodiment of the disclosure, a mid-section support plate 49 is disposed on a bottom of the circuit board 40. A mouse lens 491 is disposed on a corresponding position between the circuit board 40 and the mid-section support plate 49.

In the embodiment, a support part 11 is disposed on a front end of the housing 10.

In the embodiment, the front end of the housing 10 refers to a direction of the housing 10 facing towards the scroll wheel 41, and a direction of the housing 10 facing away from the scroll wheel 41 is a rear end of the housing 10.

In the embodiment, the housing 10 and the support part 11 are integrally formed.

In the embodiment, the support part 11 is used to fixedly connect the front end of the circuit board 40. A rear end of the circuit board 40 is connected to the housing 10, and supports the front end of the circuit board 40 upward at the same time.

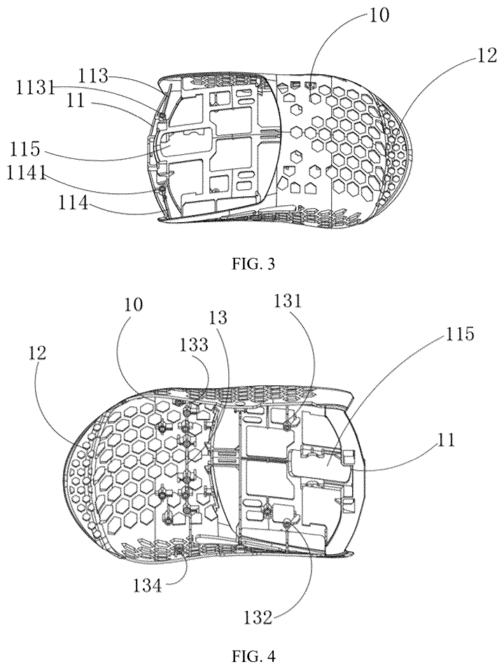

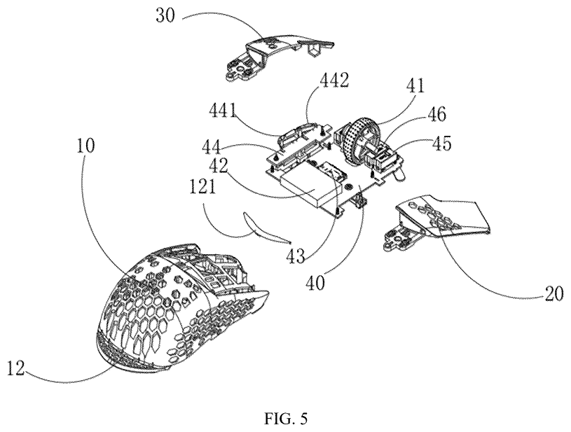

Referring to FIG. 3, FIG. 4 and FIG. 7, in the embodiment, the housing 10 defines a first through-hole 115 for installing the scroll wheel 41, and the first through-hole 115 is defined above the support part 11. The circuit board 40 defines a second through-hole 411. A bottom-half of the scroll wheel 41 is disposed on the second through-hole 411. A top-half of the scroll wheel 41 is disposed in the first through-hole 115, and exposed from the first through-hole 115, so as to facilitate the control and use of the scroll wheel 41.

The housing 10 located above the support part 11 defines the first through-hole 115, and the scroll wheel 41 is clamped in the first through-hole 115, so that the stroll wheel 41 is more stable and prevented from shaking left and right.

In the embodiment, support frames are disposed on an end of the first through-hole 115, that is, a first support frame 113 and a second support frame 114 are disposed on two sides of a front end of the first through-hole 115, and the first through-hole 115 is connected to the support part 1 through the first support frame 113 and the second support frame 114.

In the embodiment, the first support frame 113 and the second support frame 114 are disposed on the support part 11, so that the first through-hole 115 is more stable, and at the same time, the use of the stroll wheel 41 is more stable.

In the embodiment, the first support frame 113 and the second support frame 114 define a first screw hole 1131 and a second screw hole 1141 respectively. The front end of the circuit board 40 is fixedly connected to the first screw hole 1131 and the second screw hole 1141 through screws, so that the front end of the circuit board 40 is connected to the support part 11.

Referring to FIG. 4, in the embodiment, the housing 10 defines a third screw hole 133 and a fourth screw hole 134 therein. The rear end of the circuit board 40 is connected to the third screw hole 133 and the fourth screw hole 134 through screws, so that the circuit board 40 is fixedly connected to the housing 10.

In the embodiment, the housing 10 further defines a fifth screw hole 131 and a sixth screw hole 132 therein, and the fifth screw hole 131 and the sixth screw hole 132 are fixedly connected to buttons on corresponding positions on the circuit board 40. A reinforcing 13 is disposed in the housing 10, and the reinforcing 13 defines multiple positioning screw holes to fixedly connect the buttons on the corresponding positions on the circuit board 40. In this way, the circuit board 40 and the buttons on the circuit board 40 are fixedly connected to the housing 10, so as to ensure that the control input device 43 on the circuit board device can operate normally and stably.

Referring to FIG. 1, FIG. 3 and FIG. 4, in the embodiment, the support part 11 is an arc-shaped support part.

In the embodiment, the support part 11 is designed to be in an arc-shape to better adapt to the sliding of the mouse, and the control of the mouse is flexible and convenient.

In the embodiment, a first footpad 111 and a second footpad 112 are disposed on left and right sides of a bottom of the support part 11 respectively. The first footpad 111 and the second footpad 112 are used to ensure that the circuit board 40 is parallel to the desktop, making the use of the disclosure more flexible and convenient.

Referring to FIG. 1, FIG. 2, FIG. 3 and FIG. 4, in the embodiment, the rear end of the housing 10 includes a convex edge 12.

The convex edge 12 is disposed on the rear end of the housing 10, which is mainly to ensure that the disclosure is more stable in use and to avoid instability in the use of the mouse due to the inconvenience of sliding the mouse.

In the embodiment, a third footpad 121 is disposed on a bottom of the convex edge 12, and the third footpad 121 is used to ensure that the disclosure is parallel to the desktop, making the use of the disclosure more flexible and convenient.

In the embodiment, the convex edge 12 is an arc-shaped convex edge.

A shape of the convex edge 12 is designed to be an arc shape, which can better adapt to the sliding of the mouse, control the mouse flexibly, and improve the stability.

In the embodiment, in order to reduce the weight of the disclosure, the convex edge 12 is a hollow convex edge. In an embodiment, the housing 10 is a hollow housing.

In the embodiment, the shapes of the housing 10 and the convex edge 12 are designed to be hollow, which further reduces the weight of the disclosure, simplifies the structure of the disclosure, greatly reduces the manufacturing cost, and reduces the production cost.

In the embodiment, the housing 10, the support part 11 and the convex edge 12 are integrally formed.

The housing 10, the support part 11 and the convex edge 12 are integrally formed, so that assembly is simplified, work efficiency is greatly improved, and disassembly, assembly and maintenance are easier.

The disclosure abandons the bottom housing of the mouse, reduces the total weight of the mouse, improves the production and assembly efficiency, and thus provides the user with a more comfortable and convenient operating experience.

The above descriptions are merely some of the embodiments of the disclosure, and does not limit the patent scope of the disclosure. All equivalent structural changes made by using the contents of the specification and drawings of the disclosure under the concept of the disclosure, or directly/indirectly used in other related technical fields are included in the patent protection scope of the disclosure.

What is claimed is:

1. A mouse, comprising a housing, wherein the housing comprises a left button and a right button, a circuit board device is disposed in the housing, and a control input device and a scroll wheel are disposed on the circuit board device; and a support part is disposed on a front end of the housing.

2. The mouse as claimed in claim 1, wherein a rear end of the housing comprises a convex edge.

3. The mouse as claimed in claim 2, wherein the support part is an arc-shaped support part.

4. The mouse as claimed in claim 3, wherein the convex edge is an arc-shaped convex edge.

5. The mouse as claimed in claim 4, wherein a footpad is disposed on a bottom of the support part or a bottom of the convex edge.

6. The mouse as claimed in claim 5, wherein the housing is a hollow housing.

7. The mouse as claimed in claim 6, wherein the convex edge is a hollow convex edge.

8. The mouse as claimed in claim 1, wherein the housing defines a first through-hole configured to install the scroll wheel, and the first through-hole is defined above the support part.

9. The mouse as claimed in claim 8, wherein support frames are disposed on an end of the first through-hole, and the first through-hole is connected to the support part through the support frames.

10. The mouse as claimed in claim 9, wherein the housing, the support part and the convex edge are integrally formed.
